(19) United States
(12) Patent Application Publication
(10) Pub. No.: US 2010/0115089 A1
(43) Pub. Date: May 6, 2010

(54) Identifying Participants in a Conference

(76) Inventors: Gonzalo Camarillo Gonzalez, Helsinki (FI); Oscar Novo Diaz, Helsinki (FI)

Correspondence Address: ERICSSON INC., 6300 LEGACY DRIVE, M/S EVR 1-C-11, PLANO, TX, 75024, US

(21) Appl. No.: 12/522,213

(22) PCT Filed: Jan. 15, 2007
(86) PCT No.: PCT/EP2007/050355

§ 371 Date: Jul. 6, 2009

(51) Int. Cl. G06F 15/173; G06F 3/01

(52) U.S. Cl. 709/224; 715/753

(57) ABSTRACT

A method of obtaining data about all the participants in a Binary Floor Control Protocol (BFCP) conference is provided. The method comprises sending a query message from a floor participant or floor chair to a floor control server, the query message requesting information about all of the participants in the conference, and sending at least one status message from the floor control server to the floor participant, the at least one status message including information about all of the participants in the conference. These operations are performed within BFCP.

### FIELD OF THE INVENTION

The present invention relates to the identification of participants in a conference. In particular, although not exclusively, the invention relates to a system by which one participant can obtain knowledge of all the other participants in a Push-to-talk over Cellular (PoC) conference, and any conference operated according to the Binary Floor Control Protocol (BFCP).

### BACKGROUND TO THE INVENTION

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services.

IP Multimedia Subsystem (IMS) is the technology defined by the Third Generation Partnership Project (3GPP) to provide IP Multimedia services over mobile communication networks (3GPP TS 22.228, TS 23.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between user terminals (or user terminals and application servers). Whilst SIP was created as a user-to-user protocol, IMS allows operators and service providers to control user access to services and to charge users accordingly.

FIG. 1 illustrates schematically how the IMS fits into a mobile network architecture in the case of a Packet Switched (PS) and Circuit Switched (CS) access domains. Call/Session Control Functions (CSCFs) operate as SIP proxies with the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

One of the first and most important services provided by the IMS is Push-to-talk over Cellular (PoC). PoC is a multi-party conference service that is similar to a traditional “Walkie-Talkie” service. Users press and hold a button when they want to talk, but they don't start speaking until their terminal tells them to do so, and release it when they finish talking. All other users in the conference will hear the speech.

PoC has some advantages over other voice services. Traditional mobile phone networks and devices utilize full-duplex communications (using separate frequencies for transmission and reception) which allow customers to call other persons on a mobile or land-line network and be able to simultaneously talk and hear the other party. Such communications require a connection to be started by dialling a phone number and the other party answering the call, and the connection remains active until either party ends the call or the connection is dropped due to signal loss or a network outage. PoC allows casual transmissions to be sent to other parties on the network without first dialling them up, in a similar manner to two-way radios. PoC is a half-duplex service, (using a single frequency) which means that only one user can talk at a time. PoC does not require high-bandwidth links and, thus, does not require the deployment of new radio technologies.

PoC currently uses the Talk Burst Control Protocol (TBCP). TBCP is a Real Time Control Protocol (RTCP)-based floor control specific to PoC. That is, TBCP is only used in PoC.

The IETF has developed a floor control standard called Binary Floor Control Protocol (BFCP). BFCP is a general protocol that, as a binary protocol, can be used in low-bandwidth interfaces. It is possible that BFCP may replace TBCP in future versions of PoC. Some implementations of BFCP are already in use, for example in conferencing servers that provide moderated conferences.

The BFCP does not define a method to provide a floor participant with knowledge of all the participants who are participating in a conference. In order to obtain this functionality, user agents normally use the Session Initiation Protocol (SIP) Event Package for Conference State, as defined in RFC 4575.

However, the SIP Event Package for Conference State does not define any floor control related information. There is thus currently no way to obtain the floor information data of every participant.

Work is currently being performed by the IETF Centralized Conferencing (XCON) working group to develop an extension to the SIP Event Package for Conference State to support some floor information. However, many user agents do not implement the SIP Event Package for Conference State. This is because it is based on XML, and XML based protocols are not very efficient in low-bandwidth interfaces, such as some mobile networks.

### SUMMARY OF THE INVENTION

The invention generally provides for an extension to BFCP to support a request for floor information, and provides a way to obtain the floor information data of every user within BFCP. BFCP is a binary protocol which has been designed to be very efficient and does not require high-bandwidth links. As such, it is suitable for use in low-bandwidth interfaces, such as some mobile networks.

In accordance with one aspect of the present invention there is provided a method of obtaining data about participants in a BFCP conference, comprising:
sending a query message from a floor participant or floor chair to a floor control server, the query message requesting information about all of the participants in the conference; and
in response to the query message, sending at least one status message from the floor control server to the floor participant or floor chair, the at least one status message including information about all of the participants in the conference.

Thus query messages and status messages may be used, within an existing BFCP system, to obtain information about all the participants in the conference. At least two embodiments may be used: the extension of existing BFCP operations (UserQuery and UserStatus operations), and/or the provision of additional BFCP operations.

In one embodiment, the query message may include a UserQuery primitive. The UserQuery primitive is already provided for the BFCP, and a UserQuery message includes an identifier attribute (the beneficiary-id attribute) which is normally used to identify the participant about which information is requested. This identifier attribute is preferably set to a predetermined value, which may be zero, to indicate to the floor control server that information is requested about all of the participants in the conference.

The at least one status message may then comprise as many status messages as there are participants in the conference, each status message including a UserStatus primitive and containing information about one of the participants in the conference.

In an alternative embodiment, the query message includes a primitive for informing the floor control server that information is requested about all the participants in the conference. The at least one status message may then be a general status message containing information about all the participants in the conference. The general status message preferably includes a grouped attribute which contains a beneficiary-information attribute and a floor-request-information attribute for each of the participants in the conference.

Either of the above embodiments may be incorporated simply into BFCP, and provide an efficient solution. Devices with low-bandwidth interfaces, such as mobile phones, can use this solution.

The invention also provides a mobile telecommunications terminal, adapted to participate in a Binary Floor Control Protocol conference, the device being arranged to send a query message to a floor control server, the query message requesting information about all of the participants in the conference.

The invention further provides a node in an IP Multimedia Subsystem network, adapted to operate as a floor control server for a Binary Floor Control Protocol conference, the node being arranged to:
receive a query message from a floor participant requesting information about all of the participants in the conference; and
in response to the query message, send at least one status message to the floor participant, the at least one status message including information about all of the participants in the conference.

In accordance with another aspect of the present invention there is provided a method of obtaining data about participants in a mobile telecommunications conference, comprising:
sending a query message from a floor participant or floor chair to a floor control server, the query message containing an identifier attribute settable to discrete values, each value being usable to identify a participant in the conference, the identifier attribute being set to a value which informs the floor control server that information is required for all participants in the conference; and
in response to the query message, sending as many status messages as there are participants in the conference from the floor control server to the floor participant or floor chair, each status message containing information about one of the participants in the conference. The information about one of the participants in the conference in each status message preferably includes an identification of that participant.

The conference is preferably operated according to BFCP, with the query message including a UserQuery primitive and each status message including a UserStatus primitive.

In accordance with a further aspect of the present invention there is provided a method of obtaining data about participants in a mobile telecommunications conference, comprising:
sending a general query message from a floor participant or floor chair to a floor control server, the general query message containing a primitive for informing the floor control server that information is requested about all the participants in the conference; and
in response to the general query message, sending a general status message from the floor control server to the floor participant or floor chair, the general status message containing information about all the participants in the conference. The general status message preferably includes an identification of each of the participants in the conference.

The conference is preferably operated according to BFCP. The general status message may include a grouped attribute which contains a beneficiary-information attribute and a floor-request-information attribute for each of the participants in the conference.

### BRIEF DESCRIPTION OF THE DRAWINGS

FIG. 1 illustrates schematically the architecture of an IP Multimedia Subsystem in a mobile communications system.

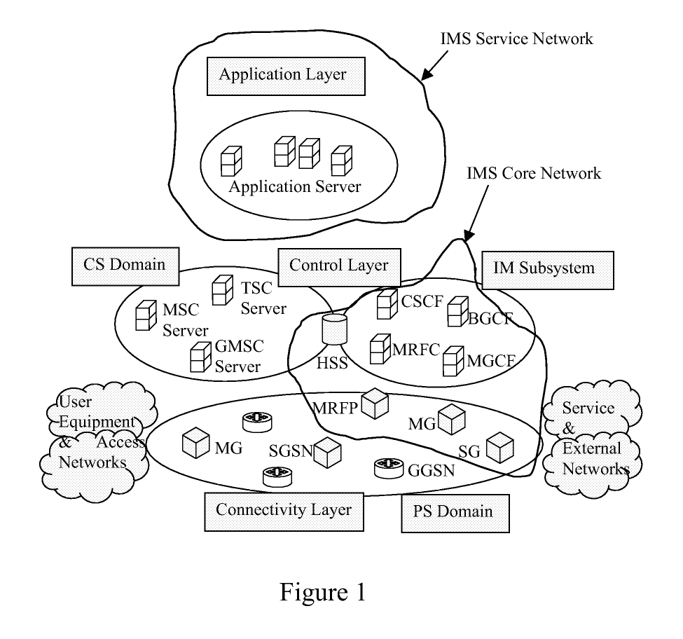

FIG. 2 is a schematic illustration of a BFCP conference.

### DETAILED DESCRIPTION OF THE PREFERRED EMBODIMENT

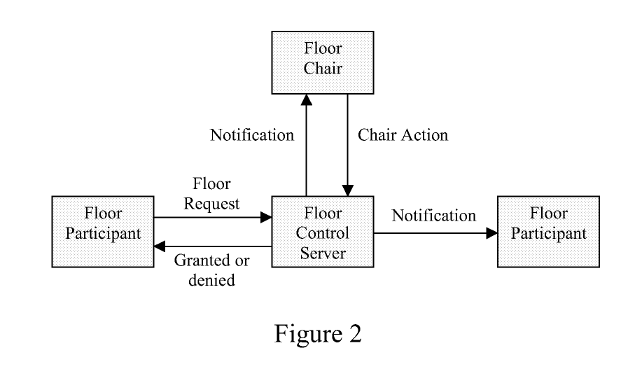

FIG. 2 illustrates the tasks currently performed by the BFCP. BFCP generally provides a means:
for floor participants to send floor requests to floor control servers.
for floor control servers to grant or deny requests to access a given resource from floor participants.
for floor chairs to send floor control servers decisions regarding floor requests.
for floor control servers to keep floor participants and floor chairs informed about the status of a given floor or a given floor request.

BFCP packets consist of a 12-octet common header followed by attributes. The common header includes an 8-bit field called a “primitive” which identifies the main purpose of the message.

BFCP specifies two primitives which are related to the request of information about a single floor participant in the conference: UserQuery and UserStatus. Redefining the behaviour of these operations enables floor participants to request floor information about all of the floor participants in the conference.

The primitive UserQuery enables a client (either a floor participant or a floor chair) to request information about another participant in the conference. This is achieved by sending the primitive to the floor control server. A UserQuery message (with the UserQuery primitive in the common header) has the following format:
UserQuery=(COMMON-HEADER)
   [BENEFICIARY-ID]
   * [EXTENSION-ATTRIBUTE]

The beneficiary-id attribute in the UserQuery message is used to identify the participant about which information is requested.

When the floor control server receives the UserQuery message, it returns a UserStatus message (with the UserStatus primitive in the common header) to the client. The UserStatus message typically contains information about the participant identified in the UserQuery message and has the following format:
UserStatus=(COMMON-HEADER)
   [BENEFICIARY-INFORMATION]
   * (FLOOR-REQUEST-INFORMATION)
   * [EXTENSION-ATTRIBUTE]

The beneficiary-id attribute in the UserQuery message is generally used to identify a single floor participant. However, this message can be modified to request floor information about all of the floor participants in the conference, by assigning a value of zero to this attribute.

On receiving a UserQuery message with a beneficiary-id attribute set to zero, the floor control server sends as many UserStatus messages as there are participants in the conference.

An alternative approach for enabling a request floor information about all of the floor participants in the conference may also be used, which does not require modification of the behaviour of the UserQuery and UserStatus messages. This alternative approach involves the use of two new BFCP messages, one to be sent by a floor participant or floor chair, and one to be sent by a floor control server. The first new message is that to be sent by the floor participant or floor chair, and this message has a format as follows:
New operation 1=(COMMON-HEADER)
   * [EXTENSION-ATTRIBUTE]

The message has the specific purpose of requesting, from the floor control server, the floor information of all of the participants in the conference, and this purpose is identified by a new primitive in the COMMON-HEADER attribute. The name of the primitive is not specified. It will be appreciated that any name and value of the new primitive may be used.

On receiving the New operation 1 message, the floor control server responds with the second new message (New operation 2), whose definition is as follows:
New operation 2=(COMMON-HEADER)
   * (NEW-ATTRIBUTE)
   * [EXTENSION-ATTRIBUTE]

This message contains information about every floor participant in the conference in the NEW-ATTRIBUTE attribute. The NEW-ATTRIBUTE attribute is a grouped attribute that contains the beneficiary-information and floor-request-information attributes:
NEW-ATTRIBUTE=(NEW-ATTRIBUTE-HEADER)
   (BENEFICIARY-INFORMATION)
   (FLOOR-REQUEST-INFORMATION)
   * [EXTENSION-ATTRIBUTE]

Every NEW-ATTRIBUTE contains information about one participant. The new message New operation 2 contains as many NEW-ATTRIBUTES attributes as a participants in the conference.

Thus the floor information for all of the participants in the conference are returned to the participant who requested this information by sending a New operation 2 message to that participant.

It will be appreciated that variations from the above described embodiments may still fall within the scope of the invention. For example, it is described that the beneficiary-id attribute in a UserQuery message can be set to zero to inform the floor control server that information is requested for all the participants in the conference. It will be appreciated that other values for the beneficiary-id could also be used, as long as they are understood by the floor control server as instructions to provide information about all participants.

1. A method of obtaining data about a plurality of participants in a mobile telecommunication conference, the method comprising:
sending a single query message from a floor participant or floor chair to a floor control server, the query message requesting information about the plurality of participants in the conference; and
in response to the query message, sending at least one status message from the floor control server to the requesting floor participant or floor chair, the at least one status message including information about the plurality of participants in the conference.

2. The method of claim 1, wherein the query message includes an identifier attribute settable to discrete values, each value being usable to identify a participant in the conference, the identifier attribute being set to a value which informs the floor control server that information is required for all participants in the conference.

3. The method of claim 2, wherein the identifier attribute in the query message is set to zero to inform the floor control server that information is required for all participants in the conference.

4. The method of claim 2, wherein the conference is operated according to the Binary Floor Control Protocol (BFCP), and wherein the identifier attribute is a BFCP beneficiary-id attribute.

5. The method of claim 1, wherein the at least one status message comprises as many status messages as there are participants in the conference, each status message including a UserStatus primitive and containing information about one of the participants in the conference.

6. The method of claim 5, wherein each status message includes an identification of one of the participants in the conference.

7. The method of claim 1, wherein the query message includes a primitive for informing the floor control server that information is requested about all the participants in the conference.

8. The method of claim 7, wherein the at least one status message is a general status message containing information about all the participants in the conference.

9. The method of claim 8, wherein the general status message includes a grouped attribute which contains a beneficiary-information attribute and a floor-request-information attribute for each of the participants in the conference.

10-16. (canceled)

17. The method of claim 1, wherein the conference is operated according to the Binary Floor Control Protocol, and wherein the query message includes a UserQuery primitive, and each status message includes a UserStatus primitive.

18-21. (canceled)

22. A mobile telecommunications terminal for participating in a mobile telecommunication conference, the terminal comprising:
means for sending a single query message to a floor control server, the query message requesting information about a plurality of participants in the conference; and
means for receiving from the floor control server, at least one status message containing information about the plurality of participants in the conference.

23. The terminal of claim 22, wherein the query message includes an identifier attribute settable to discrete values, each value being usable to identify a participant in the conference, the identifier attribute being set to a value which informs the floor control server that information is required for all participants in the conference.

24. The terminal of claim 23, wherein the at least one status message comprises as many status messages as there are participants in the conference, each status message including a UserStatus primitive and containing information about one of the participants in the conference.

25. The terminal of claim 23, wherein the at least one status message is a general status message containing information about all the participants in the conference.

26. The terminal of claim 22, wherein the conference is operated according to the Binary Floor Control Protocol, and wherein the query message includes a UserQuery primitive, and each status message includes a UserStatus primitive.

27. A floor control server in an IP Multimedia Subsystem network for controlling a Binary Floor Control Protocol (BFCP) conference, the server comprising:
means for receiving a single query message from a floor participant or floor chair requesting information about a plurality of participants in the conference; and
means responsive to receiving the query message, for sending at least one status message to the requesting floor participant or floor chair, the at least one status message including information about the plurality of participants in the conference.

28. The server of claim 27, wherein the query message includes an identifier attribute settable to discrete values, each value being usable to identify a participant in the conference, the identifier attribute being set to a value which informs the floor control server that information is required for all participants in the conference.

29. The server of claim 28, wherein the at least one status message comprises as many status messages as there are participants in the conference, each status message including a UserStatus primitive and containing information about one of the participants in the conference.

30. The server of claim 28, wherein the at least one status message is a general status message containing information about all the participants in the conference.

31. The server of claim 27, wherein the conference is operated according to the Binary Floor Control Protocol, and wherein the query message includes a UserQuery primitive, and each status message includes a UserStatus primitive.
